(19) United States
(12) Patent Application Publication
(10) Pub. No.: US 2024/0078288 A1
(43) Pub. Date: Mar. 7, 2024

(54) DATA MODELING AND PROCESSING TECHNIQUES FOR GENERATING PREDICTIVE METRICS

(71) Applicant: Optum, Inc., Minnetonka, MN (US)

(72) Inventor: Subhash Seelam, Exton, PA (US)

(21) Appl. No.: 18/063,715

(22) Filed: Dec. 9, 2022

Related U.S. Application Data
(60) Provisional application No. 63/374,825, filed on Sep. 7, 2022.

(51) Int. Cl. G06F 17/18; G06F 18/2132

(52) U.S. Cl. CPC G06F 17/18; G06F 18/21326

(57) ABSTRACT

Various embodiments of the present invention disclose techniques for implementing an automatic data processing scheme for evaluating robust data sets to optimize procedure efficiency. A method may include determining a weighting-based input data object parameter for a robust data set; determining a variance-based input data object cohort parameter for a subset of the robust data set; generating a predictive variance metric for a data object of the subset based at least in part on the variance-based input data object cohort parameter and a first predictive metric attribute for the data object; generating a predictive weighting metric for the data object based at least in part on the weighting-based input data object parameter and a second predictive metric attribute for the data object; and generating a predictive metric data object for evaluating the robust data set based at least in part on the predictive variance metric and the predictive weighting metric.

### CROSS-REFERENCE TO RELATED APPLICATIONS

This application claims the benefit of U.S. Provisional Application No. 63/374,825, entitled “Empirical Approach to Diagnose, Target, Monitor, and Adjust Care Variation Reduction Programs,” and filed Sep. 7, 2022, the entire contents of which are hereby incorporated by reference.

### BACKGROUND

Various embodiments of the present invention address technical challenges related to complex data processing techniques given limitations of existing evaluative data analysis processes. In doing so, various embodiments of the present invention make important contributions to various existing predictive and evaluative data analysis systems.

### BRIEF SUMMARY

Various embodiments of the present invention disclose data modeling and processing techniques for generating predictive and evaluative metrics from robust, complex data sets associated with a developmental process. The present disclosure is directed to an automatic data processing scheme for evaluating such data sets. Using the techniques described herein, comprehensible predictive metrics for a developmental process may be generated from large multi-faceted data sets to enable an entity to diagnose, monitor, and track inefficiencies of the process. These predictive metrics may ultimately be utilized to optimize procedure efficiency in an iterative processing scheme.

In accordance with one embodiment, a computer-implemented method for implementing an automatic data processing scheme for evaluating robust data sets to optimize procedure efficiency is provided. The computer-implemented method comprises generating, by one or more processors, a weighting-based input data object parameter for a plurality of input data objects associated with a predictive entity; generating, by the one or more processors, a variance-based input data object cohort parameter for an input data object cohort comprising a subset of input data objects from the plurality of input data objects; generating, by the one or more processors, a predictive variance metric for an input data object of the input data object cohort based at least in part on the variance-based input data object cohort parameter and a first predictive metric attribute for the input data object; generating, by the one or more processors, a predictive weighting metric for the input data object based at least in part on the weighting-based input data object parameter and a second predictive metric attribute for the input data object; generating, by the one or more processors, a predictive metric data object for the input data object based at least in part on the predictive variance metric and the predictive weighting metric for the input data object; and providing, by the one or more processors, an indication of the predictive metric data object to the predictive entity.

In accordance with another embodiment, an apparatus for implementing an automatic data processing scheme for evaluating robust data sets to optimize procedure efficiency is provided. The apparatus comprises at least one processor and at least one memory including program code, the at least one memory and the program code are configured to, with the at least one processor, cause the apparatus to at least: generate a weighting-based input data object parameter for a plurality of input data objects associated with a predictive entity; generate a variance-based input data object cohort parameter for an input data object cohort comprising a subset of input data objects from the plurality of input data objects; generate a predictive variance metric for an input data object of the input data object cohort based at least in part on the variance-based input data object cohort parameter and a first predictive metric attribute for the input data object; generate a predictive weighting metric for the input data object based at least in part on the weighting-based input data object parameter and a second predictive metric attribute for the input data object; generate a predictive metric data object for the input data object based at least in part on the predictive variance metric and the predictive weighting metric for the input data object; and provide an indication of the predictive metric data object to the predictive entity.

In accordance with yet another embodiment, a computer program product for implementing an automatic data processing scheme for evaluating robust data sets to optimize procedure efficiency is provided. The computer program product comprises at least one non-transitory computer-readable storage medium having computer-readable program code portions stored therein. The computer-readable program code portions are configured to: generate a weighting-based input data object parameter for a plurality of input data objects associated with a predictive entity; generate a variance-based input data object cohort parameter for an input data object cohort comprising a subset of input data objects from the plurality of input data objects; generate a predictive variance metric for an input data object of the input data object cohort based at least in part on the variance-based input data object cohort parameter and a first predictive metric attribute for the input data object; generate a predictive weighting metric for the input data object based at least in part on the weighting-based input data object parameter and a second predictive metric attribute for the input data object; generate a predictive metric data object for the input data object based at least in part on the predictive variance metric and the predictive weighting metric for the input data object; and provide an indication of the predictive metric data object to the predictive entity.

### BRIEF DESCRIPTION OF THE DRAWINGS

Having thus described the invention in general terms, reference will now be made to the accompanying drawings, which are not necessarily drawn to scale, and wherein:

FIG. 1 provides an exemplary overview of a system that may be used to practice embodiments of the present invention.

FIG. 2 provides an example predictive data analysis computing entity in accordance with some embodiments discussed herein.

FIG. 3 provides an example external computing entity in accordance with some embodiments discussed herein.

FIG. 4 provides a flowchart diagram of an example process for an automatic data processing scheme for evaluating robust data sets to optimize procedure efficiency in accordance with some embodiments discussed herein.

FIG. 5 provides a flowchart diagram of an example process for generating input data object cohort parameters for an input data object cohort in accordance with some embodiments discussed herein.

FIG. 6 provides a graph representation of an example input data object cohort, in accordance with some embodiments discussed herein.

FIG. 7 provides a flowchart diagram of an example process for generating a cohort predictive metric data object for an input data object cohort in accordance with some embodiments discussed herein.

FIG. 8 provides a flowchart diagram of an example process for optimizing procedure efficiency in accordance with some embodiments discussed herein.

FIG. 9A illustrates a graph representation of a first iteration operational example of an input data object cohort during a first iteration in accordance with some embodiments discussed herein.

FIG. 9B illustrates a graph representation of a second iteration operational example of an input data object cohort during a second iteration in accordance with some embodiments discussed herein.

FIG. 10 illustrates a graph representation of an optimized input data object cohort in accordance with some embodiments discussed herein.

### DETAILED DESCRIPTION

Various embodiments of the present invention are described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Terms such as “computing,” “determining,” “generating,” and/or similar words are used herein interchangeably to refer to the creation, modification, or identification of data. Like numbers refer to like elements throughout. Moreover, while certain embodiments of the present invention are described with reference to predictive data analysis, one of ordinary skill in the art will recognize that the disclosed concepts may be used to perform other types of data analysis.

### I. OVERVIEW AND TECHNICAL ADVANTAGES

Embodiments of the present invention present new data processing techniques to improve data modeling and evaluation of robust, multi-faceted datasets. To do so, the present disclosure describes an empirical approach for generating comprehensible predictive metrics that accurately demonstrate efficiencies and/or inefficiencies with a developmental process. A developmental process may include a computer-implemented and/or real-world procedure that may be evaluated and improved based at least in part on historical embodiments of the procedure. For example, during each embodiment of the procedure, data may be generated that is indicative of one or more aspects of the procedure including, as examples, a processing time, a cost incurred, an advantage gained, and/or the like for a particular object associated with the embodiment of the developmental procedure. This information may be aggregated and stored in complex, robust, multi-faceted data sets that lack processing techniques, such as those described herein, for accurately evaluating and/or improving certain aspects of the developmental process.

Embodiments of the present invention present new data structures for diagnosing, targeting, monitoring, and/or otherwise evaluating/improving one or more aspects of a developmental process. The new data structure may include a holistic predictive metric data object that may be indicative of a variation in the developmental process. The variation in the developmental process may be indicative of difference in the way different objects are handled by the developmental process that may lead to inefficiencies and/or provide insights on how to optimize the developmental process. The predictive metric data object may quantify the variation of the developmental process and holistically measure the impact of the variation on an entity's overall activities. By using the techniques described herein, a robust data set may be transformed into one comprehensible predictive metric data object that accurately represents a relative efficiency of the developmental process.

Typical techniques for evaluating the efficiency of a developmental process may overly rely on unreliable aspects of a robust data set or compare aspects of a robust data set over time without considering unavoidable time period incurred changes. For instance, in one example embodiment, a developmental process may include a clinical process in which individuals are administered care during a clinical encounter. Typical approaches for evaluating the variation in administered care may measure variations in a clinical encounter's length of stay. When a clinical encounter's stay exceeds an expected length of stay, it is assumed that excess days indicate inefficiencies with the clinical process. While comprehensible, these approaches fail to consider that the length of stay is a function of multiple factors and may be an unreliable determinative of care variation and, as a result, a poor indication of efficiency in a developmental process. Other typical approaches compare the costs for a clinical encounter to previous costs for a similar clinical encounters during a prior time period. This approach is also unreliable as it assumes that a mix of cases in every measurement period is the same.

The predictive metric data object of the present disclosure provides a technical improvement that improves the reliability and comprehensibility of previous data modeling techniques by directly comparing a plurality of instances of a developmental process against each other across a number of different parameters. As one particular example, the predictive metric data object of the present disclosure may be defined by (i) a deviation (e.g., a number of standard deviations) between a cost parameter of a first instance from a median cost parameter for a group of instances, and (ii) an advantage contribution (e.g., a revenue attributed to) of an instance to a total advantage incurred from each instance of the developmental process. In a clinical context, for example, the predictive metric data object may include a measure of the degree of dispersion in clinical care adjusted for revenue contribution to demonstrate opportunity for further improvement. This single unit of measurement may consider multiple influencing components, weighted based at least in part on variable importance and its contribution to health system revenue, and creates a normalized method of comparing departments within a hospital as well as peer group hospitals. As described herein, the predictive metric data object may be measured across an entire hospital or stratified into subcomponents like service lines, diagnosis related groupings, cost centers, etc. to help evaluate areas where a development process is working well and where it has no impact or negative return.

In this manner, the new data processing techniques of the present disclosure improve quality, while reducing costs and boosting efficiencies for developmental processes such as clinical processes. This is achieved by evaluating and optimizing variation between different instances of the developmental process. The variation solutioning techniques of the present disclosure enable a predictive entity to (i) identify clusters of instances where variation in a developmental process is chronic, (ii) guide predictive entities to further optimize one or more different aspects of the developmental process based at least in part on targeted clusters of variation, and (iii) iteratively evaluate and monitor variation in the developmental process over time. Moreover, the predictive metric data object may be leveraged by predictive entities to measure quality, star ratings, payer initiatives to control costs, facility recommendations, and/or the like.

The term “input data object” may refer to a data entity that describes a data point of interest for a process optimization scheme. The input data object may be associated with a developmental process. As examples, the input data object may identify a case and/or record of clinical operations that may be optimized through the data modeling and processing techniques described herein. The input data object, for example, may include a clinical encounter and/or a clinical encounter.

The term “input data object parameter” may refer to a data entity that describes an attribute of an input data object. The input data object may be associated with a plurality of input data object parameters that may describe a plurality of attributes for the input data object. The plurality of attributes may include one or more characteristics that may be relevant to a developmental process. By way of example, the parameters may include contextual attributes for the input data object and/or predictive metric attributes for the input data object.

The term “predictive entity” may refer to a data entity that describes a common attribute for a plurality of input data objects involved in a developmental process. The predictive entity may be based at least in part on the developmental process. As one example, the developmental process may include clinical operations and the predictive entity may be a hospital and/or health care provider that is configured to facilitate the clinical operations. As other examples, the developmental process may include an object management process and the predictive entity may be an object provider and/or producer that is configured to facilitate the object management process.

The term “contextual attribute” may refer to a data entity that describes a contextual component of an input data object. An input data object may include one or more contextual attributes that may describe contextual information for grouping one or more different input data objects into input data object cohorts. By way of example, an input data object may include a clinical encounter for an individual. In such an example, a contextual attribute may include the individual's age, an attending physician, a relevant disease, comorbidities, hospital, and/or like. In some embodiments, a contextual attribute may include one or more classifications associated with an input data object. As examples, the classifications may include Medicare Severity Diagnosis. Related Groups (MSDRG), All Patient Refined Diagnosis Related Groups (APRDRG), Severity of Illness (SOI), principal/primary diagnosis/procedure, and/or the like.

The term “predictive metric attribute” may refer to a data entity that describes a predictive component of an input data object. A predictive component of an input data object may be based at least in part a developmental process. The predictive component may be an indicator of variation in the developmental process. As one example, in a clinical context, a predictive metric attribute may be predictive of care variation for the developmental process. Example predictive metric attributes may include a cost parameter (e.g., a total direct cost associated with the input data object), a timing parameter (e.g., a length of stay for the input data object), an advantage parameter (e.g., a revenue accrued by the input data object), and/or the like.

The term “input data object cohort” may refer to a subset of a plurality of input data objects. Each of the subset of input data objects may include one or more similar contextual attributes. By way of example, an input data object cohort may be defined by one or more input data object classifications. For instance, the subset of input data objects may include one or more input data objects that are each associated with a MSDRG classification, an APRDRG, an SOI classification, principal/primary diagnosis/procedure classification, and/or the like. In one embodiment, for example, an input data object cohort may be defined based at least in part on a MSDRG classification. In addition, or alternatively, an input data object cohort may be defined based at least in part on an APRDRG and SOI classification, an MSDRG and SOI, a principal/primary diagnosis/procedure classification, and/or the like.

The term “input data object cohort parameter” may refer to a data entity that describes a generated predictive component of an input data object cohort. A predictive component of an input data object cohort may be based at least in part a developmental process. In some embodiments, an input data object cohort parameter may be based at least in part on a plurality of respective predictive metric attributes for each of respective input data object of an input data object cohort. For instance, an input data object parameter may include an aggregate predictive attribute and/or one or more statistical measurements for the plurality of respective predictive metric attributes. By way of example, an input data object cohort parameter may include a variance-based input data object cohort parameter and/or a timing-based input data object cohort parameter. The variance-based input data object cohort parameter may include a median cost parameter for an input data object cohort. The median cost parameter may identify a median direct cost for the subset of input data objects of an input data object cohort. The timing-based input data object cohort parameter may include a median time parameter for an input data object cohort. The median time parameter may identify a median length of stay for the subset of input data objects of an input data object cohort.

The term “predictive metric data object” may refer to a data entity that describes a relative variance of an input data object relative to an input data object cohort and/or a plurality of input data objects including the input data object cohort. The relative variance of an input data object may be based at least in part on a comparison between one or more predictive metric attributes of an input data object with the input data object cohort parameters and/or one or more parameters associated with the plurality of input data objects. The relative variance of the input data object may be measured based at least in part on the developmental process. In some embodiments, the relative variance of the input data object may be represented by an aggregation of one or more predictive metric data object parameters.

The term “predictive metric data object parameter” may refer to a data entity that describes a predictive component of a predictive metric data object. A predictive metric data object parameter may be predictive of a relative variance of an input data object with respect to a developmental process. In some embodiments, a predictive metric data object parameter may include a predictive variance metric, a predictive timing metric, and/or a predictive weighting metric. In addition, or alternatively, a predictive metric data object parameter may include a predictive metric attribute such as, for example, a cost parameter (e.g., a direct cost, etc.) for the input data object. By way of example, a predictive metric data object may include a product of the cost parameter, a predictive variance metric, and/or a predictive weighting metric for a respective input data object.

The term “predictive variance metric” may refer to a component of the predictive metric data object. The predictive variance metric may describe a variance of the input data object relative to an input data object cohort. The predictive variance metric for an input data object may be based at least in part on a comparison between a predictive metric attribute (e.g., a cost parameter, a timing parameter, etc.) of an input data object with one or more input data object cohort parameters for an input data object cohort.

By way of example, the predictive variance metric may be indicative of a number of standard deviations between a cost parameter (e.g., a direct cost, etc.) of an input data object and a variance-based input data object cohort parameter (e.g., a median cost parameter) for an input data object cohort. In addition, or alternatively, the predictive variance metric may be indicative of a number of standard deviations between a timing parameter (e.g., a length of stay, etc.) of the input data object and a timing-based input data object cohort parameter (e.g., a median timing parameter) for the input data object cohort. In addition, or alternatively, the predictive variance metric may be indicative of a number of standard deviations between a timing parameter (e.g., a length of stay, etc.) of the input data object and a timing-based input data object cohort parameter (e.g., a median timing parameter) for the input data object cohort

The term “predictive weighting metric” may refer to a component of the predictive metric data object. The predictive weighting metric may describe a magnitude of the input data object relative to a plurality of input data objects associated with a predictive entity. The predictive weighting metric for an input data object may be based at least in part on a comparison between a predictive metric attribute of an input data object with a weighting-based input data object parameter for the plurality of input data objects associated with the predictive entity. The predictive metric attribute and/or the weighting-based input data object parameter may be based at least in part on the developmental process.

By way of example, the predictive metric attribute may include an advantage metric (e.g., a revenue accrued by, etc.) for the input data object and the weighting-based input data object parameter may be determined based at least in part on an aggregate of a plurality of advantage parameters respectfully associated with each of the plurality of input data objects. The predictive weighting metric may be generated based at least in part on an advantage ratio between the advantage parameter and the aggregate advantage parameter. In some embodiments, for example, the weighting-based input data object parameter may include a total revenue accrued by the plurality of input data objects for the predictive entity. The predictive weighting metric may be indicative of a revenue contribution of an input data object as a percentage of a total revenue from the plurality of input data objects.

The term “cohort predictive metric data object” may refer to a data entity that describes a relative variance of an input data object cohort with respect to a plurality of input data objects that include the input data object cohort. In some embodiments, the cohort predictive metric data object may include an aggregation of a predictive metric data object for each respective input data object of an input data object cohort. The cohort predictive metric data object, for example, may include an average predictive metric data object for the input data object cohort.

The term “optimization cohort cluster” may refer to one or more outlier input data objects of an input data object cohort that are associated with one or more predictive metric attributes that are at least a threshold distance from one or more input data object cohort parameters of an input data object cohort. The one or more outlier input data objects, for example, may each be associated with a respective predictive metric data object that is at least a threshold distance from a cohort predictive metric data object for an input data object cohort.

The term “shared cluster attribute” may refer to a data entity that describes one or more respective input data object parameters that are shared by at least a portion of an optimization cohort cluster.

The term “processing optimization action” may refer to a data entity that describes an action for optimizing a developmental process. As an examples, the developmental process may include clinical operations that may be optimized through the data modeling and processing techniques described herein. The processing optimization action may include a dynamic processing recommendation for improving the clinical operations.

### II. COMPUTER PROGRAM PRODUCTS, METHODS, AND COMPUTING ENTITIES

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as in a particular directory, folder, or library. Software components may be static (e.g., pre-established or fixed) or dynamic (e.g., created or modified at the time of execution).

A computer program product may include non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid-state drive (SSD)), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatuses, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### III. EXAMPLE SYSTEM FRAMEWORK

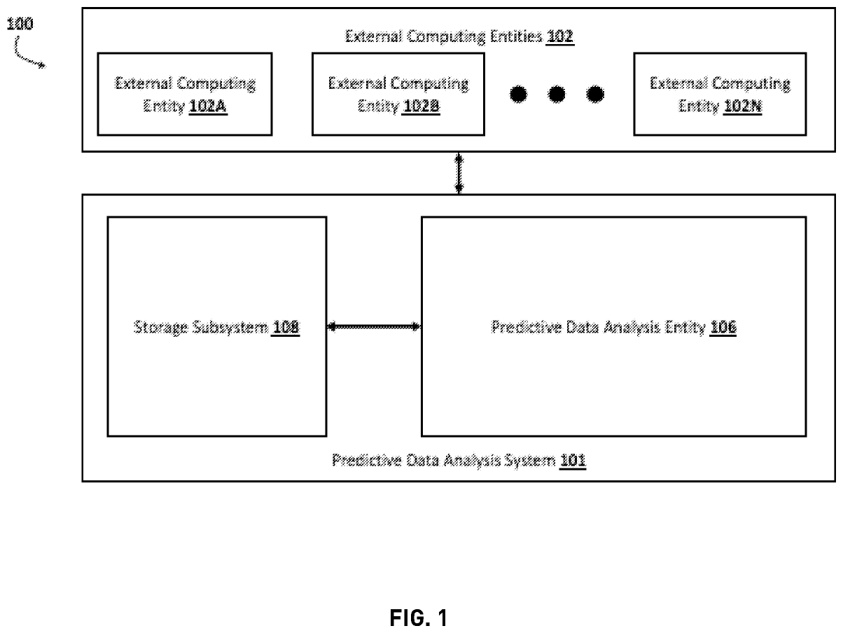

FIG. 1 provides an example overview of a system 100 that may be used to practice embodiments of the present disclosure. The system 100 includes a predictive data analysis system 101 comprising a predictive data analysis computing entity 106 configured to generate outputs that may be used to perform one or more output-based actions. The predictive data analysis system 101 may communicate with one or more external computing entities 102A-N using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (e.g., network routers, and/or the like).

The system 100 includes a storage subsystem 108 configured to store at least a portion of the data utilized by the predictive data analysis system 101. The predictive data analysis computing entity 106 may be in communication with the external computing entities 102A-N. The predictive data analysis computing entity 106 may be configured to: (i) train one or more machine learning models based on a training data store stored in the storage subsystem 108, (ii) store trained machine learning models as part of a model definition data store of the storage subsystem 108, (iii) utilize trained machine learning models to perform an action, and/or the like.

In one example, the system predictive data analysis computing entity 106 may be configured to generate a prediction, classification, and/or any other data insight based on data provided by an external computing entity such as external computing entity 102A, external computing entity 102B, and/or the like.

The storage subsystem 108 may be configured to store the model definition data store and the training data store for one or more machine learning models. The predictive data analysis computing entity 106 may be configured to receive requests and/or data from at least one of the external computing entities 102A-N, process the requests and/or data to generate outputs (e.g., predictive outputs, classification outputs, and/or the like), and provide the outputs to at least one of the external computing entities 102A-N. In some embodiments, the external computing entity 102A, for example, may periodically update/provide raw and/or processed input data to the predictive data analysis system 101. The external computing entities 102A-N may further generate user interface data (e.g., one or more data objects) corresponding to the outputs and may provide (e.g., transmit, send, and/or the like) the user interface data corresponding with the outputs for presentation to the external computing entity 102A (e.g., to an end-user).

The storage subsystem 108 may be configured to store at least a portion of the data utilized by the predictive data analysis computing entity 106 to perform one or more steps/operations and/or tasks described herein. The storage subsystem 108 may be configured to store at least a portion of operational data and/or operational configuration data including operational instructions and parameters utilized by the predictive data analysis computing entity 106 to perform the one or more steps/operations described herein. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

The predictive data analysis computing entity 106 may include an analysis engine and/or a training engine. The predictive analysis engine may be configured to perform one or more data analysis techniques. The training engine may be configured to train the predictive analysis engine in accordance with the training data store stored in the storage subsystem 108.

### Example Predictive Data Analysis Computing Entity

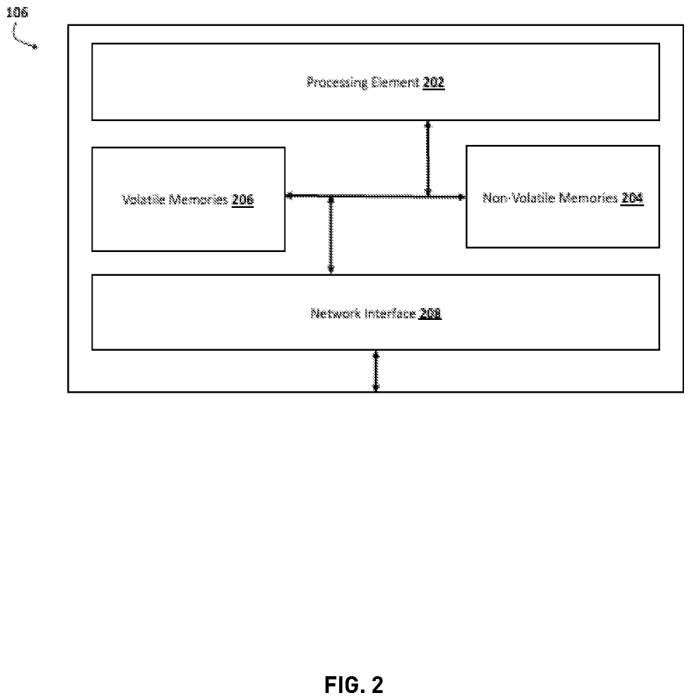

FIG. 2 provides an example predictive data analysis computing entity 106 in accordance with some embodiments discussed herein. In general, the terms computing entity, computer, entity, device, system, and/or similar words used herein interchangeably may refer to, for example, one or more computers, computing entities, desktops, mobile phones, tablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, steps/operations, and/or processes described herein. Such functions, steps/operations, and/or processes may include, for example, transmitting, receiving, operating on, processing, displaying, storing, determining, creating/generating, monitoring, evaluating, comparing, and/or similar terms used herein interchangeably. In one embodiment, these functions, steps/operations, and/or processes may be performed on data, content, information, and/or similar terms used herein interchangeably.

The predictive data analysis computing entity 106 may include a network interface 208 for communicating with various computing entities, such as by communicating data, content, information, and/or similar terms used herein interchangeably that may be transmitted, received, operated on, processed, displayed, stored, and/or the like.

In one embodiment, the predictive data analysis computing entity 106 may include or be in communication with a processing element 202 (also referred to as processors, processing circuitry, and/or similar terms used herein interchangeably) that communicate with other elements within the predictive data analysis computing entity 106 via a bus, for example. As will be understood, the processing element 202 may be embodied in a number of different ways including, for example, as at least one processor/processing apparatus, one or more processors/processing apparatuses, and/or the like.

For example, the processing element 202 may be embodied as one or more complex programmable logic devices (CPLDs), microprocessors, multi-core processors, coprocessing entities, application-specific instruction-set processors (ASIPs), microcontrollers, and/or controllers. Further, the processing element 202 may be embodied as one or more other processing devices or circuitry. The term circuitry may refer to an entirely hardware embodiment or a combination of hardware and computer program products. Thus, the processing element 202 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 202 may be configured for a particular use or configured to execute instructions stored in one or more memory elements including, for example, one or more volatile memories 206 and/or non-volatile memories 204202. As such, whether configured by hardware or computer program products, or by a combination thereof, the processing element 202 may be capable of performing steps or operations according to embodiments of the present disclosure when configured accordingly. The processing element 202, for example in combination with the one or more volatile memories 206 and/or or non-volatile memories 204, may be capable of implementing one or more computer-implemented methods described herein. In some embodiments, the predictive data analysis computing entity 106 may include a computing apparatus, the processing element 202 may include at least one processor of the computing apparatus, and the one or more volatile memories 206 and/or non-volatile memories 204 may include at least one memory including program code. The at least one memory and the program code may be configured to, upon execution by the at least one processor, cause the computing apparatus to perform one or more steps/operations described herein.

The non-volatile memories 204 (also referred to as non-volatile storage, memory, memory storage, memory circuitry, media, and/or similar terms used herein interchangeably) may include at least one non-volatile memory device 204, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile memories 204 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

The one or more volatile memories (also referred to as volatile storage, memory, memory storage, memory circuitry, media, and/or similar terms used herein interchangeably) may include at least one volatile memory 206 device, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile memories 206 may be used to store at least portions of the databases, database instances, database management systems, data, applications, programs, program modules, scripts, source code, object code, byte code, compiled code, interpreted code, machine code, executable instructions, and/or the like being executed by, for example, the processing element 202. Thus, the databases, database instances, database management systems, data, applications, programs, program modules, scripts, source code, object code, byte code, compiled code, interpreted code, machine code, executable instructions, and/or the like may be used to control certain embodiments of the operation of the predictive data analysis computing entity 106 with the assistance of the processing element 202.

As indicated, in one embodiment, the predictive data analysis computing entity 106 may also include the network interface 208 for communicating with various computing entities, such as by communicating data, content, information, and/or the like that may be transmitted, received, operated on, processed, displayed, stored, and/or the like. Such communication data may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the predictive data analysis computing entity 106 may be configured to communicate via wireless client communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

### Example External Computing Entity

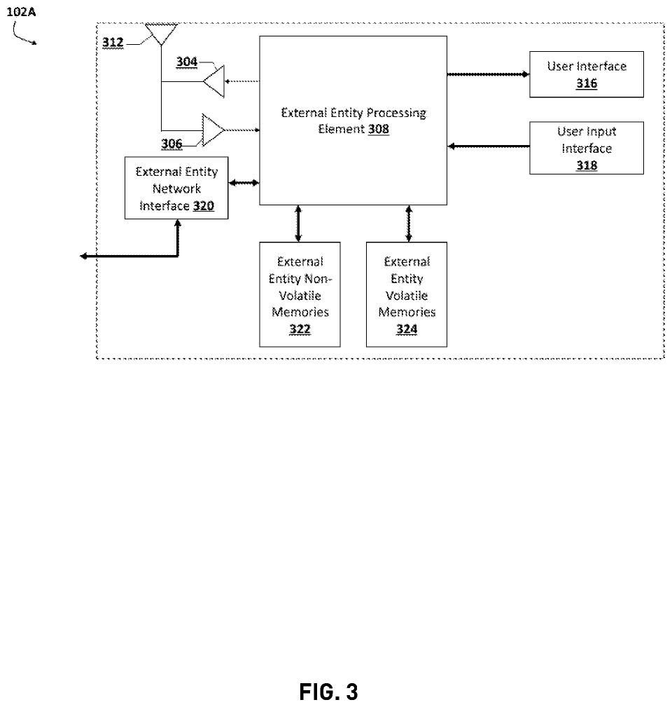

FIG. 3 provides an example external computing entity 102A in accordance with some embodiments discussed herein. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, steps/operations, and/or processes described herein. The external computing entities 102A-N may be operated by various parties. As shown in FIG. 3, the external computing entity 102A may include an antenna 312, a transmitter 304 (e.g., radio), a receiver 306 (e.g., radio), and/or an external entity processing element 308 (e.g., CPLDs, microprocessors, multi-core processors, coprocessing entities, ASIPs, microcontrollers, and/or controllers) that provides signals to and receives signals from the transmitter 304 and the receiver 306, correspondingly. As will be understood, the external entity processing element 308 may be embodied in a number of different ways including, for example, as at least one processor/processing apparatus, one or more processors/processing apparatuses, and/or the like as described herein with reference the processing element 202.

The signals provided to and received from the transmitter 304 and the receiver 306, correspondingly, may include signaling information/data in accordance with air interface standards of applicable wireless systems. In this regard, the external computing entity 102A may be capable of operating with one or more air interface standards, communication protocols, modulation types, and access types. More particularly, the external computing entity 102A may operate in accordance with any of a number of wireless communication standards and protocols, such as those described above with regard to the predictive data analysis computing entity 106. In a particular embodiment, the external computing entity 102A may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the external computing entity 102A may operate in accordance with multiple wired communication standards and protocols, such as those described above with regard to the predictive data analysis computing entity 106 via an external entity network interface 320.

Via these communication standards and protocols, the external computing entity 102A may communicate with various other entities using means such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 102A may also download changes, add-ons, and updates, for instance, to its firmware, software (e.g., including executable instructions, applications, program modules), operating system, and/or the like.

According to one embodiment, the external computing entity 102A may include location determining embodiments, devices, modules, functionalities, and/or the like. For example, the external computing entity 102A may include outdoor positioning embodiments, such as a location module adapted to acquire, for example, latitude, longitude, altitude, geocode, course, direction, heading, speed, universal time (UTC), date, and/or various other information/data. In one embodiment, the location module may acquire data such as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating a position of the external computing entity 102A in connection with a variety of other systems, including cellular towers, Wi-Fi access points, and/or the like. Similarly, the external computing entity 102A may include indoor positioning embodiments, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning embodiments may be used in a variety of settings to determine the location of someone or something to within inches or centimeters.

The external computing entity 102A may include a user interface 316 (e.g., a display, speaker, and/or the like) that may be coupled to the external entity processing element 308. In addition, or alternatively, the external computing entity 102A may include a user input interface 319 (e.g., keypad, touch screen, microphone, and/or the like) coupled to the external entity processing element 308).

For example, the user interface 316 may be a user application, browser, and/or similar words used herein interchangeably executing on and/or accessible via the external computing entity 102A to interact with and/or cause the display, announcement, and/or the like of information/data to a user. The user input interface 318 may comprise any of a number of input devices or interfaces allowing the external computing entity 102A to receive data including, as examples, a keypad (hard or soft), a touch display, voice/speech interfaces, motion interfaces, and/or any other input device. In embodiments including a keypad, the keypad may include (or cause display of) the conventional numeric (0-9) and related keys (#, *, and/or the like), and other keys used for operating the external computing entity 102A and may include a full set of alphabetic keys or set of keys that may be activated to provide a full set of alphanumeric keys. In addition to providing input, the user input interface 318 may be used, for example, to activate or deactivate certain functions, such as screen savers, sleep modes, and/or the like.

The external computing entity 102A may also include one or more external entity non-volatile memories 322 and/or one or more external entity volatile memories 324, which may be embedded within and/or may be removable from the external computing entity 102A. As will be understood, the external entity non-volatile memories 322 and/or the external entity volatile memories 324 may be embodied in a number of different ways including, for example, as described herein with reference the non-volatile memories 204 and/or the external volatile memories 206.

### IV. EXEMPLARY SYSTEM OPERATIONS

As described below, various embodiments of the present invention leverage robust data processing techniques to make important technical contributions to data and data processing intensive developmental processes.

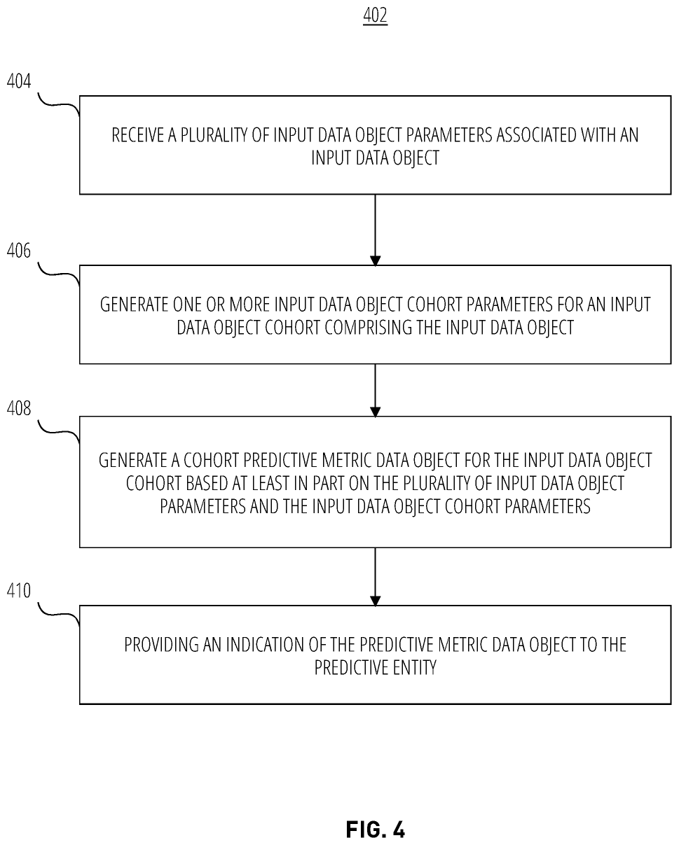

FIG. 4 provides a flowchart diagram of an example process 402 for an automatic data processing scheme for evaluating robust data sets to optimize procedure efficiency in accordance with some embodiments discussed herein. The dataflow diagram depicts an automatic data processing scheme for generating insights for a developmental process based at least in part on a plurality of input data objects associated with the developmental process. The automatic data processing scheme may be implemented by one or more computing device(s) and/or system(s) described herein. For example, the predictive data analysis computing entity 106 may utilize the automatic data processing scheme to overcome the various limitations with conventional data modeling, processing, and evaluative techniques.

At step/operation 404, the process 402 may include receiving a plurality of input data object parameters associated with an input data object. For example, the predictive data analysis computing entity 106 may receive the plurality of input data object parameters.

An input data object may include a data entity that describes a data point of interest for a developmental process. The input data object may be associated with the developmental process. As examples, in a clinical context, the input data object may identify a case and/or record of clinical operations that may be optimized through the data modeling and processing techniques described herein. The input data object, for example, may include a clinical encounter and/or a clinical encounter.

The input data object parameters may include parameters that may describe attributes of the input data object. The input data object, for example, may be associated with a plurality of input data object parameters that may describe a plurality of attributes for the input data object. The plurality of attributes may include one or more characteristics that may be relevant to the developmental process. By way of example, the input data object parameters may include contextual attributes for the input data object and/or predictive metric attributes for the input data object.

The contextual attributes for the input data object may describe contextual components of the input data object. The input data object may include one or more contextual attributes that may describe contextual information for grouping one or more different input data objects into input data object cohorts. By way of example, in a clinical context, an input data object may include a clinical encounter for an individual. In such an example, a contextual attribute may include the individual's age, an attending physician, a relevant disease, comorbidities, hospital, and/or like. In some embodiments, a contextual attribute may include one or more classifications associated with an input data object. As examples, in a clinical context, the classifications may include an MSDRG classification, APRDRG classification, SOI classification, principal/primary diagnosis/procedure classification, and/or the like.

The predictive metric attributes may describe a predictive component of an input data object. A predictive component of an input data object may be based at least in part a developmental process. Each predictive component may be an indicator of variation in the developmental process. As one example, in a clinical context, a predictive metric attribute may be predictive of care variation in the developmental process. Example predictive metric attributes may include a cost parameter (e.g., a total direct cost associated with the input data object), a timing parameter (e.g., a length of stay for the input data object), an advantage parameter (e.g., a revenue accrued by the input data object), and/or the like.

At step/operation 406, the process 402 may include generating one or more input data object cohort parameters for an input data object cohort. For example, the predictive data analysis computing entity 106 may generate the one or more input data object cohort parameters for an input data object cohort that includes the input data object.

An input data object cohort may include a subset of a plurality of input data objects that are associated with a predictive entity. The predictive entity, for example, may describe a common attribute for a plurality of input data objects that are involved in the developmental process. The predictive entity may be based at least in part on the developmental process. As one example, the developmental process may include clinical operations and the predictive entity may be a hospital and/or health care provider that is configured to facilitate the clinical operations. As other examples, the developmental process may include an object management process and the predictive entity may be an object provider and/or producer that is configured to facilitate the object management process.

A subset of the input data objects may include one or more shared contextual attributes. For example, in a clinical context, the subset of input data object may include input data objects associated with individuals of a certain age, a certain clinical category, etc. By way of example, an input data object cohort may be defined by one or more input data object classifications. For instance, the subset of input data objects may include one or more input data objects that are each associated with a MSDRG classification, an APRDRG, an SOI classification, principal/primary diagnosis/procedure classification, and/or the like. In one embodiment, for example, an input data object cohort may be defined based at least in part on a MSDRG classification. In addition, or alternatively, an input data object cohort may be defined based at least in part on a combination of an APRDRG and SOI classification, a combination of an MSDRG and SOI classification, a principal diagnosis/primary procedure, and/or the like.

The one or more input data object cohort parameters for the input data object cohort may describe a generated predictive component of the input data object cohort. The predictive component of an input data object cohort may be based at least in part the developmental process. In some embodiments, an input data object cohort parameter may be based at least in part on a plurality of respective predictive metric attributes for each respective input data object of the input data object cohort. For instance, an input data object cohort parameter may include an aggregate predictive attribute and/or one or more statistical measurements for the plurality of respective predictive metric attributes. By way of example, an input data object cohort parameter may include a variance-based input data object cohort parameter and/or a timing-based input data object cohort parameter.

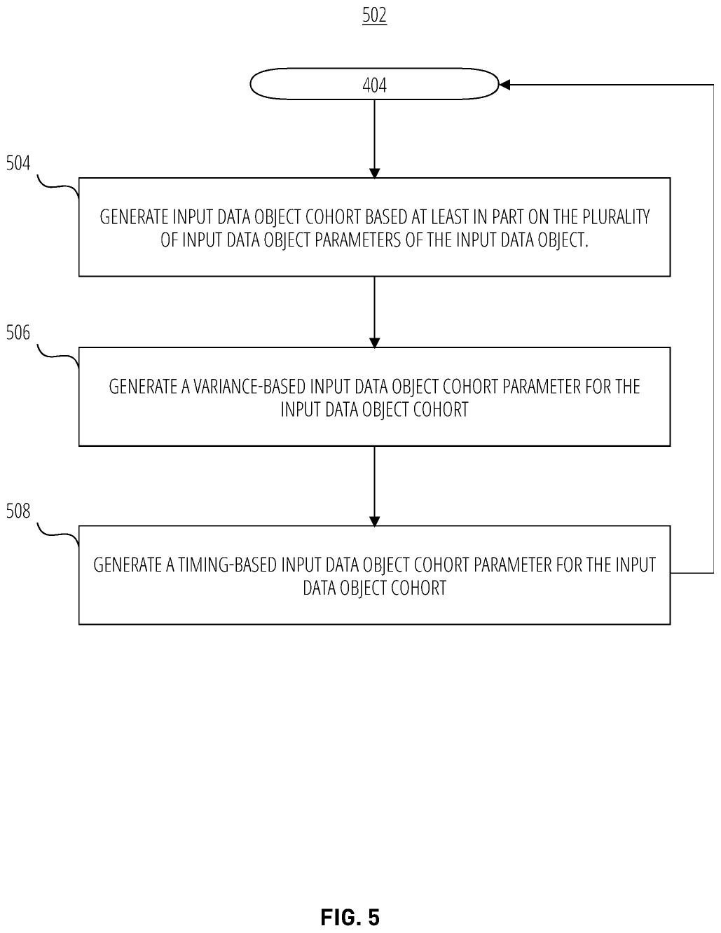

FIG. 5 provides a flowchart diagram of an example process 502 for generating input data object cohort parameters for an input data object cohort in accordance with some embodiments discussed herein. In some embodiments, the process 502 may include a plurality of operations subsequent to step/operation 406 of FIG. 4, where the process 402 includes determining one or more input data object cohort parameters for the input data object cohort. In addition, or alternatively, the process 502 may include one or more sub-operations of step/operation 406 of FIG. 4.

At step/operation 504, the process 502 may include generating an input data object cohort based at least in part on the plurality of input data object parameters. For example, the predictive data analysis computing entity 106 may generate the input data object cohort based at least in part on a plurality of input data object parameters associated with each respective input data object of the plurality of input data objects associated with the predictive entity. The input data object cohort, for example, may include a subset of a plurality of input data objects that include one or more shared contextual attributes as described herein.

At step/operation 506, the process 502 may include determining a variance-based input data object cohort parameter for the input data object cohort. For example, the predictive data analysis computing entity 106 may determine the variance-based input data object cohort parameter for the input data object cohort. The variance-based input data object cohort parameter may include a median cost parameter for the input data object cohort. The median cost parameter, for example, may identify a median direct cost for the subset of input data objects of the input data object cohort.

At step/operation 508, the process 502 may include determining a timing-based input data object cohort parameter for the input data object cohort. For example, the predictive data analysis computing entity 106 may determine the timing-based input data object cohort parameter for the input data object cohort. The timing-based input data object cohort parameter may include a median time parameter for an input data object cohort. The median time parameter may identify a median length of stay for the subset of input data objects of the input data object cohort.

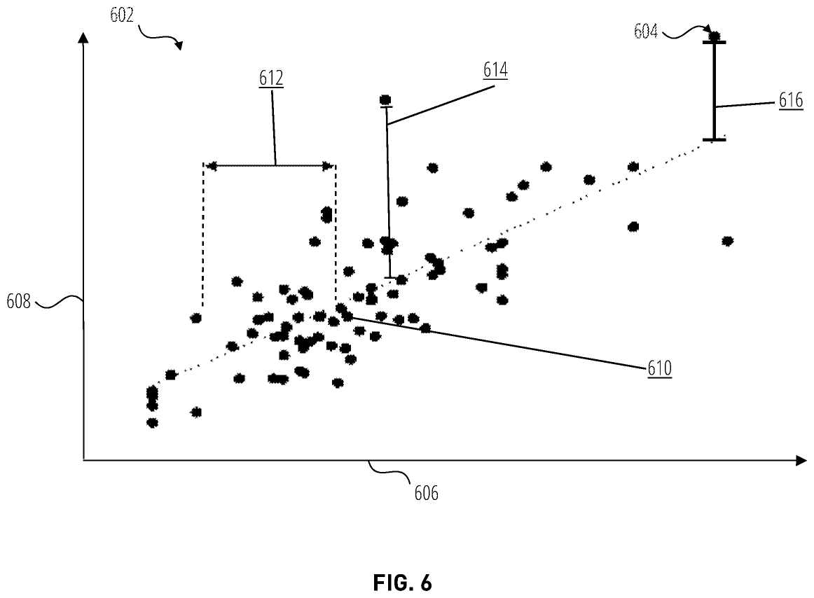

FIG. 6 provides a graph representation of an example input data object cohort 602, in accordance with some embodiments discussed herein. The graph representation includes a subset of data points plotted at one or more locations along an x and y axis. Each data point may be representative of an input data object 604 of the input data object cohort 602. The input data object 604 is placed at a location of the graph representation based at least in part on the plurality of input data object parameters associated with the input data object 604. For example, the x-axis may represent a timing-based range 606 and the y-axis may represent a variance-based range 608. The x-coordinate of the input data object 604 may be based at least in part on a timing parameter (e.g., a length of stay, etc.) of the input data object 604. The y-coordinate of the input data object 604 may be based at least in part on a cost parameter (e.g., a direct cost, etc.) of the input data object 604.

The one or more input data object cohort parameters 610 for the input data object cohort 602 may be represented by a data point associated with the timing-based input data object cohort parameter and the variance-based input data object cohort parameter of the input data object cohort. A distance from the timing-based input data object cohort parameter 612 may be indicative of a first predictive variance of a respective input data object. A distance from the variance-based input data object cohort parameter 614 may be indicative of a second predictive variance of the respective input data object. In some embodiments, a predictive variance metric 616 for the input data object 604 may be indicative of the distance from the variance-based input data object cohort parameter 614 and the distance from the timing-based input data object cohort parameter 612.

In a clinical context, the graph representation may illustrate a level of care variation for one or more clinical operations using a variance-based input data object cohort parameter such as, for example, a cost of treatment and/or a timing-based input data object cohort parameter such as, for example, a length of stay as proxies for variation. The degree of dispersion illustrated by the graph representation may be indicative of the level of care variation. Using the data modeling and processing techniques of the present disclosure, a degree of dispersion in the clinical context and other developmental processes may be evaluated to determine variation trends and/or actions for addressing the variation trends. In a clinical context, the variation trends may be addressed by evaluating variation in intensive care unit days, pharmacy costs, lab orders, imaging requests, and/or the like.

Turning back to FIG. 4, at step/operation 408, the process 402 may include generating a cohort predictive metric data object for the input data object cohort based at least in part on the plurality of input data object parameters and the input data object cohort parameters. For example, the predictive data analysis computing entity 106 may generate the cohort predictive metric data object for the input data object cohort based at least in part on the plurality of input data object parameters and the input data object cohort parameters.

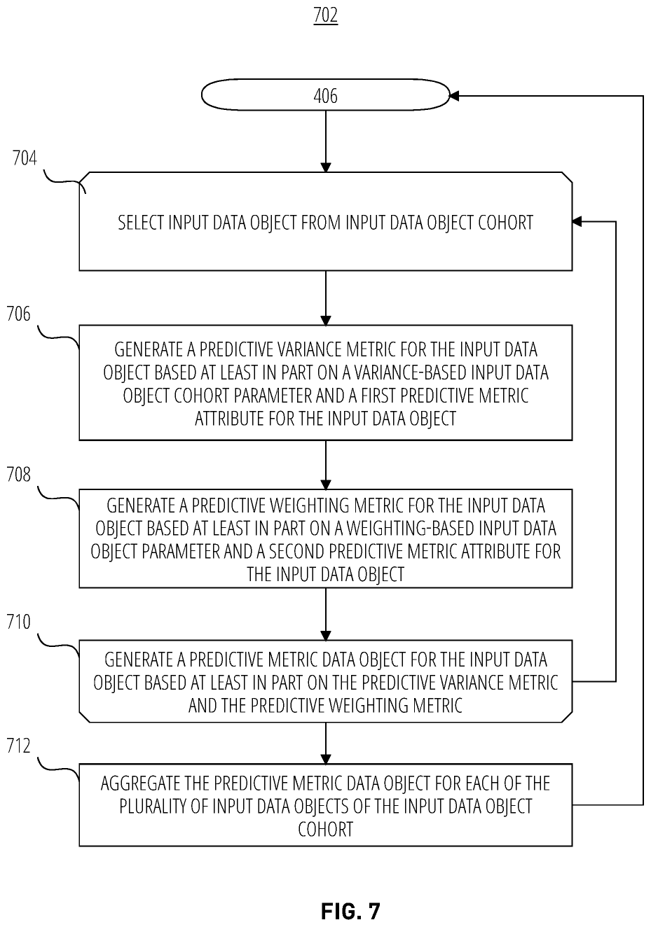

FIG. 7 provides a flowchart diagram of an example process 702 for generating a cohort predictive metric data object for an input data object cohort in accordance with some embodiments discussed herein. In some embodiments, the process 702 may include a plurality of operations subsequent to step/operation 408 of FIG. 4, where the process 402 includes generating the cohort predictive metric data object for the input data object cohort based at least in part on the plurality of input data object parameters and the input data object cohort parameters. In addition, or alternatively, the process 702 may include one or more sub-operations of step/operation 408 of FIG. 4.

At step/operation 704, the process 702 may include selecting an input data object from input data object cohort. For example, the predictive data analysis computing entity 106 may individually select one or more input data objects from the subset of input data objects of the input data object cohort for processing. In some embodiments, each input data object may be individually selected and processed to determine an individual, input data object level predictive metric data object.

At step/operation 706, the process 702 may include generating a predictive variance metric for the input data object based at least in part on the variance-based input data object cohort parameter and a first predictive metric attribute for the input data object. For example, the predictive data analysis computing entity 106 may generate the predictive variance metric for the input data object of the input data object cohort based at least in part on the variance-based input data object cohort parameter and the first predictive metric attribute for the input data object.

The predictive variance metric may include one component of a predictive metric data object for the input data object. For instance, the predictive variance metric may describe a variance of the input data object relative to the input data object cohort. The predictive variance metric for the input data object may be based at least in part on a comparison between a predictive metric attribute (e.g., a cost parameter, a timing parameter, etc.) of an input data object with the one or more input data object cohort parameters for the input data object cohort.

By way of example, the predictive variance metric may be indicative of a number of standard deviations between a cost parameter (e.g., a direct cost, etc.) of the input data object and the variance-based input data object cohort parameter (e.g., a median cost parameter) for the input data object cohort. In addition, or alternatively, the predictive variance metric may be indicative of a number of standard deviations between a timing parameter (e.g., a length of stay, etc.) of the input data object and the timing-based input data object cohort parameter (e.g., a median timing parameter) for the input data object cohort.

For instance, the predictive data analysis computing entity 106 may measure the predictive variance metric by the number of standard deviations between the cost parameter and the variance-based input data object cohort parameter. The variance-based input data object cohort parameter for the input data object cohort, for example, may be determined based at least in part on a median cost parameter of the input data object cohort. The predictive data analysis computing entity 106 may determine the number of standard deviations between the input data object and the variance-based input data object cohort parameter based at least in part on the cost parameter and the median cost parameter. The predictive data analysis computing entity 106 may generate the predictive variance metric for the input data object based at least in part on the number of standard deviations between the input data object and the variance-based input data object cohort parameter.

In addition, or alternatively, the predictive data analysis computing entity 106 may generate the predictive variance metric for the input data object of the input data object cohort based at least in part on a timing-based input data object cohort parameter and a third predictive metric attribute for the input data object. The third predictive metric attribute, for example, may include a timing parameter that is indicative of a timing associated with the input data object. The timing-based input data object cohort parameter for the input data object cohort may be determined based at least in part on a median timing parameter of the input data object cohort. The predictive data analysis computing entity 106 may determine a number of standard deviations between the input data object and the timing-based input data object cohort parameter based at least in part on the timing parameter and the median timing parameter. The predictive data analysis computing entity 106 may generate the predictive variance metric for the input data object based at least in part on the number of standard deviations between the input data object and the timing-based input data object cohort parameter.

As one example, in a clinical context, the first predictive metric attribute may be indicative of a cost parameter for the input data object that describes a direct cost for a clinical encounter. The input data object may be defined as a complete episode of care—from a time an individual enters a place of care (e.g., hospital) to a time that the individual leaves (e.g., is discharged) the place of care. During this stay, there may be various costs recorded such as, for example, a cost of drugs, cost of intensive care unit facilities, imaging, laboratory tests, and/or the like. The direct cost may include the sum of all costs incurred during the complete episode of care.

In this context, the variance-based input data object cohort parameter may refer to a median cost parameter of input data objects that are considered similar in clinical complexity. A cost parameter for an input data object may include one or more costs attributed to the use of resources and/or supplies in providing clinical operations for the input data object. The predictive variance metric may include a number of standard deviations between the cost parameter of a particular input data object and the median cost parameter for the input data object cohort. The standard deviations from the median cost may represent a degree of variation. In this way, a clinical encounter that incur costs that are further from a median cost for providing similar care may be assigned a higher weight compared to those that incur costs that are relatively closer to the median cost for providing similar care.

At step/operation 708, the process 702 may include generating a predictive weighting metric for the input data object based at least in part on the weighting-based input data object parameter and a second predictive metric attribute for the input data object. For example, the predictive data analysis computing entity 106 may generate the predictive weighting metric for the input data object based at least in part on the weighting-based input data object parameter and the second predictive metric attribute for the input data object.

The predictive weighting metric may include a component of a predictive metric data object. The predictive weighting metric, for example, may be indicative of a magnitude of the input data object relative to the plurality of input data objects associated with the predictive entity. The predictive weighting metric for an input data object may be based at least in part on a comparison between a second predictive metric attribute of the input data object with a weighting-based input data object parameter that is associated with the plurality of input data objects associated with the predictive entity.

The second predictive metric attribute may be based at least in part on the developmental process. In some embodiments, the second predictive metric attribute may be indicative of an advantage parameter (e.g., a revenue accrued by, etc.) for the input data object. The advantage parameter may be indicative of a relative benefit provided by the input data object. By way of example, in a clinical context, an advantage parameter may include an actual and/or expected reimbursement (e.g., revenue) for a clinical encounter.

The weighting-based input data object parameter may be based at least in part on the developmental process. In some embodiments, the weighting-based input data object parameter for the plurality of input data objects associated with the predictive entity may be determined based at least in part on the advantage parameter for each input data object of the plurality of input data object. For example, the weighting-based input data object parameter may include an aggregate advantage parameter of the plurality of input data objects. For instance, the predictive data analysis computing entity 106 may determine the weighting-based input data object parameter based at least in part on an aggregate of a plurality of advantage parameters respectfully associated with each of the plurality of input data objects. By way of example, in a clinical context, the weighting-based input data object parameter may include a total revenue accrued by the plurality of input data objects for the predictive entity.

The predictive weighting metric may be generated based at least in part on an advantage ratio between the advantage parameter and the aggregate advantage parameter. For example, the predictive data analysis computing entity 106 may determine an advantage ratio between the advantage parameter of the input data object and the aggregate advantage parameter of the plurality of input data objects. The predictive data analysis computing entity 106 may generate the predictive weighting metric for the input data object based at least in part on the advantage ratio. In this way, the predictive weighting metric may be used to weigh the input data object according to the input data object's contribution to a desired advantage. In some embodiments, the predictive weighting metric for the input data object may be combined with predictive weighting metrics generated for each of the subset of input data objects of the input data object cohort to determine a combined advantage achieved by the input data object cohort. The combined advantage may be utilized to prioritize processing optimization actions to maximize impact for a desired outcome.

By way of example, in a clinical context, the predictive weighting metric may be indicative of a revenue contribution of the input data object as a percentage of a total revenue accrued by the predictive entity from the plurality of input data objects. For example, the predictive weighting metric may be indicative of a revenue contribution of a clinical encounter as a percent of total hospital revenue. In this context, a combined advantage achieved by the input data object cohort may represent a combined revenue achieved by a subset of clinical encounter. This may be utilized to prioritize intervention efforts for episodes of care to intelligently address different care variation problems by focusing prioritization efforts on groups of clinical encounters that may have the maximum impact on a predictive entity's total revenue.

As one example, a first example input data object cohort may include input data objects associated with chest pain DRG and a second example input data object cohort may include input data objects associated with hip and knee replacement DRG. Both the first and second input data object cohorts may have similar levels of variation (e.g., predictive variance metrics) and have similar annual volume. However, the first example input data object cohort may generate 4-5 times revenue compared with the second input data object cohort. By including the predictive weighting metric, a cohort predictive metric data object may be generated for each input data object cohort that accurately reflects each input data object cohorts' relative impact on a desired outcome.

At step/operation 710, the process 702 may generate a predictive metric data object for the input data object based at least in part on the predictive variance metric and the predictive weighting metric. For example, the predictive data analysis computing entity 106 may generate the predictive metric data object for the input data object based at least in part on the predictive variance metric and the predictive weighting metric for the input data object. In some embodiments, the predictive metric data object may be generated by aggregating the first predictive metric attribute, the predictive variance metric, and/or the predictive weighting metric for the input data object. The predictive metric data object, for example, may include the product of the first predictive metric attribute (e.g., a cost parameter), the predictive variance metric, and/or the predictive weighting metric for the input data object.

By way of example, in a clinical context, the predictive metric data object may include the product of a direct cost (e.g., a cost parameter), a number of standard deviations from a median cost of an input data object cohort (e.g., a predictive variance metric), and a revenue contribution weight (e.g., a predictive weighting metric) for the input data object. In some embodiments, the predictive metric data object may be calculated as a function of the log(cost parameter)*predictive variance metric*predictive weighting metric. In this way, direct cost incurred by a predictive entity (e.g., a hospital, etc.) may be used as a proxy to identify variation.

At step/operation 712, the process 702 may aggregate the predictive metric data object for each input data object of the plurality of input data objects of the input data object cohort to generate a cohort predictive metric data object. For example, the predictive data analysis computing entity 106 may generate the cohort predictive metric data object based at least in part on the predictive metric data object for the input data object. The cohort predictive metric data object may be indicative of an average predictive metric data object for the input data object cohort. By way of example, the predictive metric data object for the input data object may be calculated as a function of the log(cost parameter)*predictive variance metric*predictive weighting metric. The cohort predictive metric data object may be calculated as a function of (the sum of each respective predictive metric data object for each input data object of the input data object cohort)/(the number of input data objects within the subset of input data objects of the input data object cohort)×100.

Turning back to FIG. 4, at step/operation 410, the process 402 may include providing an indication of the cohort predictive metric data object to the predictive entity. For example, the predictive data analysis computing entity 106 may provide the indication of the cohort predictive metric data object for the input data object cohort and/or a predictive metric data object for one or more input data objects of the input data object cohort.

By way of example, the predictive data analysis computing entity 106 may initiate a presentation of an interactive evaluation user interface. The interactive evaluation user interface may include a plurality of interactive widgets, each indicative of one or more components of the input data object cohort. As an example, the interactive widgets may include one or more interactive input data object widgets indicative of a respective input data object of an input data object cohort. In addition, or alternatively, the interactive widgets may include one or more interactive evaluation widgets indicative of the cohort predictive metric data object for the input data object cohort and/or a predictive metric data object for one or more input data objects of the input data object cohort. In some embodiments, the interactive evaluation user interface may include graph representation such as, for example, the graph representations depicted herein. The graph representation of the interactive evaluation user interface may include a plurality of interactive data points that are positioned relative to one another to represent a variance of one or more input data objects within an input data object cohort. In this manner, the present disclosure present a new user interface specifically tailored to the evaluation of a developmental process. The new user interface may improve developmental operations by efficiently providing information for optimizing procedure efficiency.

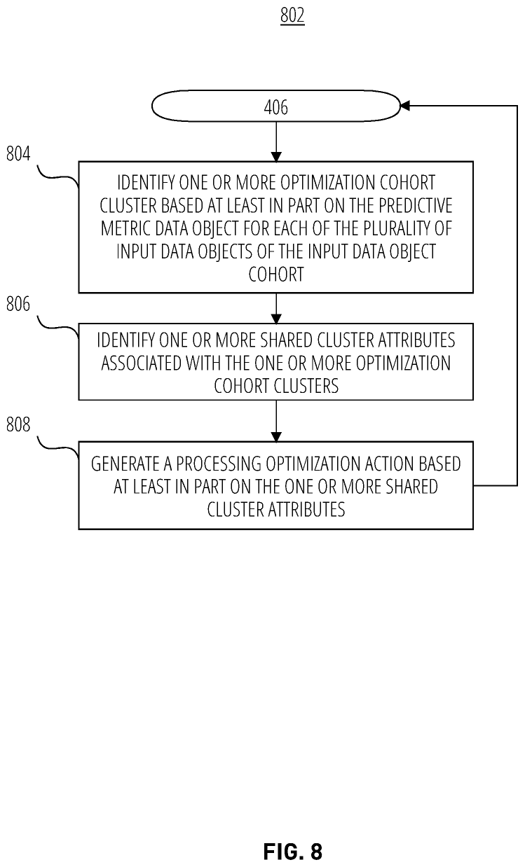

FIG. 8 provides a flowchart diagram of an example process 802 for optimizing procedure efficiency in accordance with some embodiments discussed herein. In some embodiments, the process 802 may include a plurality of operations subsequent to step/operation 408 of FIG. 4, where the process 402 includes generating the cohort predictive metric data object for the input data object cohort based at least in part on the plurality of input data object parameters and the input data object cohort parameters.

At step/operation 804, the process 802 may include identifying one or more optimization cohort clusters based at least in part on the predictive metric data object for each of the plurality of input data objects of the input data object cohort. For example, the predictive data analysis computing entity 106 may identify an optimization cohort cluster for the input data object cohort based at least in part on the cohort predictive metric data object and a plurality of predictive metric data objects corresponding to each input data object of the input data object cohort. The optimization cohort cluster may include one or more outlier input data objects of the input data object cohort.

For example, optimization cohort cluster may include one or more outlier input data objects of an input data object cohort that are associated with one or more predictive metric attributes that are at least a threshold distance from one or more input data object cohort parameters of an input data object cohort. The one or more outlier input data objects, for example, may each be associated with a respective predictive metric data object that is at least a threshold distance from the cohort predictive metric data object for the input data object cohort. The predictive data analysis computing entity 106 may generate and track predictive metric data objects over time to both identify optimization cohort clusters that are contributing more toward process variation problems (e.g., care variation, etc.) as well as monitor process efficiencies (e.g., intervention efficacy, etc.).

The optimization cohort cluster may be identified at the individual input data object level. For example, the predictive data analysis computing entity 106 may compare predictive metric data object parameters determined for the input data object to one or more variation thresholds. As one example, the variation threshold may be indicative of a threshold predictive variance metric for the input data object cohort. The threshold predictive variance metric may be based at least in part on the predictive variance metrics generated for each of the input data objects of the input data object cohort. For instance, the threshold predictive variance metric may be indicative of a maximum predictive variance metric for the input data object cohort. In addition, or alternatively, the threshold predictive variance metric may be indicative of a desired predictive variance metric for the input data object cohort. An input data object may be included in the optimization cohort cluster if the input data object's predictive variance metric exceeds the threshold predictive variance metric. By way of example, if an input data object cohort includes predictive variance metrics indicative of one or more deviation intervals (sample deviation intervals: 1-2, 2-3, 3-4, 4-5 and >5), an input data object with a predictive variance metric that is >5 deviation could be included in the optimization cohort cluster (e.g., as low hanging opportunity encounters).

As another example, the variation threshold may be indicative of a threshold predictive metric data object for the input data object cohort. The threshold predictive metric data object may be based at least in part on the predictive metric data objects generated for each of the input data objects of the input data object cohort. For instance, the threshold predictive metric data object may be indicative of a maximum and/or desired maximum predictive metric data object for the input data object cohort. An input data object may be included in the optimization cohort cluster if the input data object's predictive metric data object exceeds the threshold predictive metric data object. By way of example, if an input data object cohort includes predictive metric data objects indicative of one or more index intervals (sample index intervals: 1-2, 2-3, 3-4, 4-5 and >5), an input data object with a predictive metric data object that is >5 could be included in the optimization cohort cluster (e.g., as low hanging opportunity encounters).

In some embodiments, the optimization cohort cluster may be refined to remove at least one deceptive input data object. A deceptive input data object may include an input data object that is associated with predictive variance metric and/or predictive metric data object that may be deceptive due to one or more contextual attributes that inappropriately drive predictive metric attributes of the input data object. By way of example, in a clinical context, a clinical encounter may include a deceptive timing metric (e.g., a length of stay, etc.) due to a contextual attribute such as an incorrect assignment of a coding group due to clinical documentation accuracy.

To ensure that deceptive input data objects are removed from an optimization cohort cluster, one or more variation categorizations may be identified for a particular developmental process. In a clinical context, for example, drivers of care variation may be categorized as (a) avoidable clinical variation, (b) avoidable non-clinical variation, and/or (c) unavoidable non-clinical variation. Avoidable clinical variations may include (i) care delays due to delayed length of care review, longer pre-inpatient stays, delays in imaging/lab test results, number of specialty consultations, and/or the like, (ii) cost center outliers such as high intensive care usage, high imaging usage, high-cost drugs, high lab usage, high device costs, and/or the like, (iii) hospital-acquired conditions, and/or (iv) glucometric measures such as hyperglycemic and/or hypoglycemic. Avoidable non-clinical variations may include incorrect coding such as, for example, deceptive upcoding and/or down-coding scenarios. Unavoidable non-clinical care variation may include placement issues such as, for example, custodial delays and/or non-custodial delays.

In some embodiments, each input data object may be assigned a variation category based at least in part on contextual attributes of the input data object. Deceptive input data objects that are assigned a variation category that is not a targeted variation category may be removed from an optimization cohort cluster. By way of example, in the clinical context, the variation categories may help exclude input data objects that are not categorized as an avoidable clinical variation category. In this way, an optimization cohort cluster may help accurately diagnose a clinical problem in which clinical interventions are more targeted.

In some embodiments, the one or more variation categories may be assigned to each input data object and the cohort predictive metric data object may be generated based at least in part on the one or more variation categorizations. For example, the cohort predictive metric data object may exclude input data objects that are not assigned to a particular variation categorization. In a clinical context, for example, this may include excluding all input data objects that are not categorized as an avoidable clinical variation category. In this way, the introduction of variation categorizations may help a predictive entity accurately diagnose, target, and/or monitor the care variation problems.

At step/operation 806, the process 802 may include identifying one or more shared cluster attributes associated with the one or more optimization cohort clusters. For example, the predictive data analysis computing entity 106 may identify the one or more shared cluster attributes. A shared cluster attribute may describe one or more respective input data object parameters that are shared by at least a portion of an optimization cohort cluster. The shared cluster attributes may identify portions of a developmental process that may lead to process variation and/or inefficiencies. By identifying the shared cluster attributes, the predictive data analysis computing entity 106 may focus on targeted problem areas of a developmental process for further optimization. By way of example, in a clinical context, the shared cluster attributes may identify one or more aspects of an avoidable clinical variation that may be reduced.

In some embodiments, a targeted cohort predictive metric data object may be generated based at least in part on an input data object parameter to evaluate a contribution of a targeted parameter to the cohort predictive metric data object. In some embodiments, the input data object parameter may be based at least in part on the one or more shared cluster attributes. A plurality of targeted cohort predictive metric data objects may be generated to individually evaluate a plurality of different aspects of a developmental process. Each targeted cohort predictive metric data object may be generated by selectively rolling up one or more portions (e.g., input data objects with a targeted parameter) of the input data object cohort at a desired stratum.

By way of example, in a clinical context, a targeted parameter may include a particular physician and/or group of physicians. The particular physician and/or group of physicians' contributions to a care variation problem may be measured by rolling up the predictive metric data objects for each input data object sharing the targeted parameter (e.g., physician/group of physicians) into a targeted cohort predictive metric data object. The performance of the targeted parameter (e.g., physician/group of physicians) may be monitored by tracking the targeted cohort predictive metric data objects over time.

At step-operation 808, the process 802 may include generating a processing optimization action based at least in part on the one or more shared cluster attributes. For example, the predictive data analysis computing entity 106 may generate the processing optimization action for the predictive entity based at least in part on the optimization cohort cluster. The processing optimization action for the predictive entity may be based at least in part on one or more shared cluster attributes associated with the at least one of the one or more outlier input data objects of the optimization cohort cluster.

The processing optimization action may include a processing recommendation for improving the cohort predictive metric data object of the input data object cohort. By way of example, the processing optimization action may describe an action for optimizing a developmental process. As an example, the developmental process may include clinical operations that may be optimized through the data modeling and processing techniques described herein. The processing optimization action may include a dynamic processing recommendation for improving the clinical operations.

In some embodiments, the processing optimization action may be implemented by the predictive entity and the developmental process may be monitored to iteratively evaluate improvements or reduction in the process efficiency. By way of example, the predictive data analysis computing entity 106 may initiate the processing optimization action. The predictive data analysis computing entity 106 may generate a second iteration cohort predictive metric data object for a second set of input data objects received after the initiation of the processing optimization action. The efficacy of the processing optimization action may be evaluated based at least in part on the second iteration cohort predictive metric data object.

In some embodiments, the predictive data analysis computing entity 106 may include a machine learning model for generating the processing optimization action based at least in part on the developmental process, the input data objects, the input data object cohort, and/or the one or more shared cluster attributes. The machine learning model may include a predictive model that is trained over training data to reduce the cohort predictive metric data object for a respective input data object cohort. By way of example, the cohort predictive metric data object may include a loss function that is optimized by the machine learning model.

In some embodiments, the predictive data analysis computing entity 106 may be configured to iteratively generate processing optimization actions after each iteration of an evaluation process until an optimization threshold is achieved. For example, the predictive data analysis computing entity 106 may compare a cohort predictive metric data object to an optimization threshold. Responsive to the cohort predictive metric data object parameter not achieving the optimization threshold, the predictive data analysis computing entity 106 may generate another processing optimization action for the predictive entity. Responsive to the cohort predictive metric data object parameter achieving the optimization threshold, the predictive data analysis computing entity 106 may pause the generation of processing optimization actions for the predictive entity.

This process may continue until an optimization threshold is achieved.

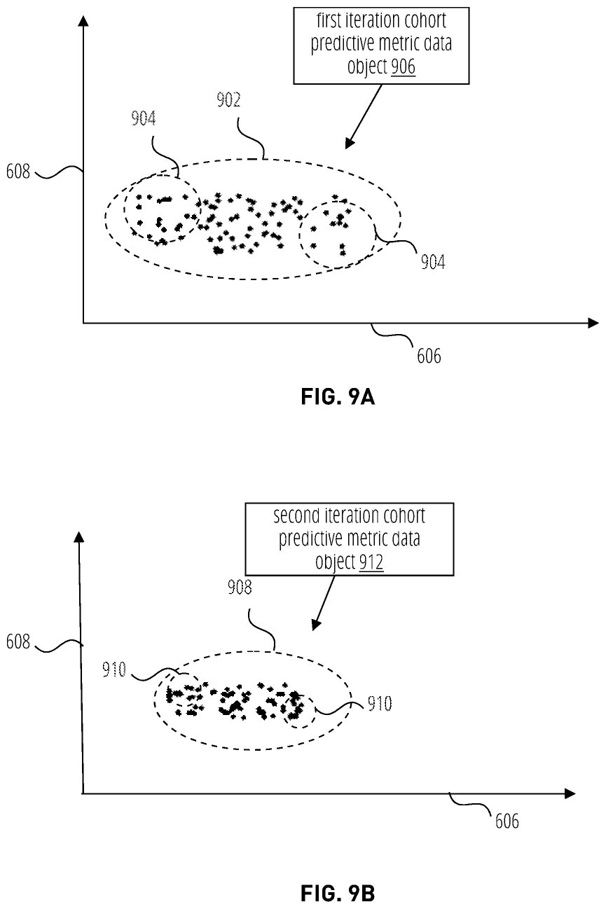

For example, FIG. 9A illustrates a graph representation of a first iteration input data object cohort 902 during a first iteration in accordance with some embodiments discussed herein. The graph representation includes a subset of data points plotted at one or more locations along an x and y axis. Each data point may be representative of an input data object of a first iteration input data object cohort 902. The x-axis may represent a timing-based range 606 and the y-axis may represent a variance-based range 608. The x-coordinate of each input data object may be based at least in part on a timing parameter of the input data object and the y-coordinate of the input data object may be based at least in part on a cost parameter of the input data object.

The first iteration input data object cohort 902 may include a degree of dispersion that may be evaluated by a first iteration cohort predictive metric data object 906 generated in accordance with the techniques of the present disclosure. The first iteration input data object cohort 902 may include one or more first iteration optimization cohort clusters 904. Each first iteration optimization cohort cluster 904 may include one or more outlier input data objects that increase the first iteration cohort predictive metric data object 906 (e.g., degree of dispersion) of the first iteration input data object cohort 902. The outlier input data objects may be processed to generate a first iteration processing optimization action for improving the first iteration cohort predictive metric data object 906 in accordance with the techniques of the present disclosure.

FIG. 9B illustrates a graph representation a second iteration input data object cohort 908 during a second iteration in accordance with some embodiments discussed herein. The graph representation includes a subset of data points plotted at one or more locations along an x and y axis. Each data point may be representative of an input data object of a second iteration input data object cohort 908. The x-axis may represent a timing-based range 606 and the y-axis may represent a variance-based range 608. The x-coordinate of each input data object may be based at least in part on a timing parameter of the input data object and the y-coordinate of the input data object may be based at least in part on a cost parameter of the input data object.

The second iteration input data object cohort 908 may include a degree of dispersion that may be evaluated by a second iteration cohort predictive metric data object 912 generated in accordance with the techniques of the present disclosure. The second iteration input data object cohort 908 may include a subset of input data objects that are evaluated after the initiation of the first iteration processing optimization action. An improved degree of dispersion may be reflected by a second iteration cohort predictive metric data object 912 that is lower than the first iteration cohort predictive metric data object 906 of FIG. 9A.

The second iteration input data object cohort 908 may include one or more second iteration optimization cohort clusters 910. Each second iteration optimization cohort cluster 910 may include one or more outlier input data objects that increase the second iteration cohort predictive metric data object 912 (e.g., degree of dispersion) of the second iteration input data object cohort 908. The outlier input data objects may be processed to generate a second iteration processing optimization action for improving the second iteration cohort predictive metric data object 912. This may be repeated over a plurality of iterations until a cohort predictive metric data object achieves an optimization threshold.

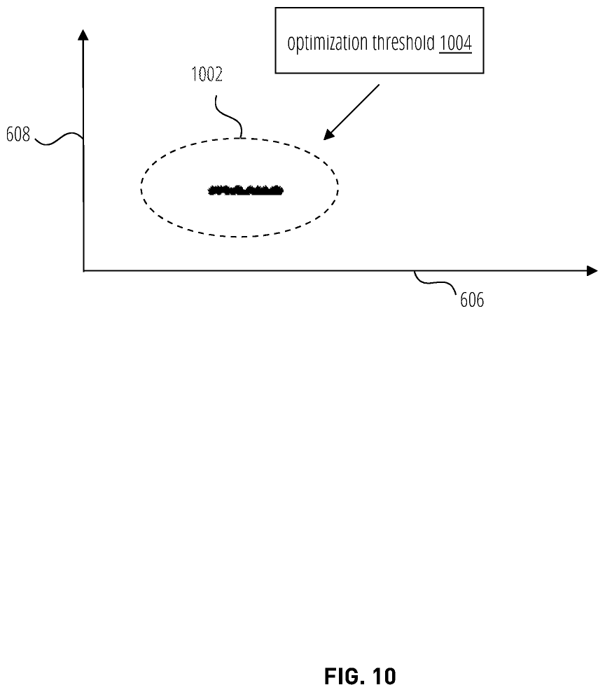

FIG. 10 illustrates a graph representation of an optimized input data object cohort 1002 in accordance with some embodiments discussed herein. The graph representation includes a subset of data points plotted at one or more locations along an x and y axis. Each data point may be representative of an input data object of an optimized input data object cohort 1002. The optimized input data object cohort 1002 may include a degree of dispersion that may be evaluated by a cohort predictive metric data object generated in accordance with the present disclosure. In this case, the cohort predictive metric data object may achieve an optimization threshold 1004 that may identify a tightly coupled group of input data objects that achieve a desired variability.

### V. CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for implementing an automatic data processing scheme for evaluating robust data sets to optimize procedure efficiency, the computer-implemented method comprising:
generating, by one or more processors, a weighting-based input data object parameter for a plurality of input data objects associated with a predictive entity;
generating, by the one or more processors, a variance-based input data object cohort parameter for an input data object cohort comprising a subset of input data objects from the plurality of input data objects;
generating, by the one or more processors, a predictive variance metric for an input data object of the input data object cohort based at least in part on the variance-based input data object cohort parameter and a first predictive metric attribute for the input data object;
generating, by the one or more processors, a predictive weighting metric for the input data object based at least in part on the weighting-based input data object parameter and a second predictive metric attribute for the input data object;
generating, by the one or more processors, a predictive metric data object for the input data object based at least in part on the predictive variance metric and the predictive weighting metric for the input data object; and
providing, by the one or more processors, an indication of the predictive metric data object to the predictive entity.

2. The computer-implemented method of claim 1, wherein the predictive variance metric is indicative of a number of standard deviations between the input data object and the variance-based input data object cohort parameter for the input data object cohort.

3. The computer-implemented method of claim 2, wherein the first predictive metric attribute is indicative of cost parameter for the input data object, and wherein generating the predictive variance metric for the input data object comprises:
generating, by the one or more processors, the variance-based input data object cohort parameter for the input data object cohort based at least in part on a median cost parameter of the input data object cohort;
determining, by the one or more processors, the number of standard deviations between the input data object and the variance-based input data object cohort parameter based at least in part on the cost parameter and the median cost parameter; and
generating, by the one or more processors, the predictive variance metric for the input data object based at least in part on the number of standard deviations between the input data object and the variance-based input data object cohort parameter.

4. The computer-implemented method of claim 1, wherein generating the predictive metric data object for the input data object comprises:
aggregating, by the one or more processors, the first predictive metric attribute, the predictive variance metric, and the predictive weighting metric for the input data object.

5. The computer-implemented method of claim 1, wherein generating the predictive variance metric for the input data object further comprises:
generating, by the one or more processors, the predictive variance metric for the input data object of the input data object cohort based at least in part on a timing-based input data object cohort parameter and a third predictive metric attribute for the input data object, wherein the third predictive metric attribute is indicative of a timing associated with the input data object.

6. The computer-implemented method of claim 1, wherein the predictive weighting metric is indicative of a magnitude of the input data object relative to the plurality of input data objects associated with the predictive entity.

7. The computer-implemented method of claim 6, wherein the second predictive metric attribute is indicative of an advantage parameter for the input data object, wherein generating the predictive weighting metric comprises:
generating, by the one or more processors, the weighting-based input data object parameter for the input data object cohort based at least in part on an aggregate advantage parameter of the plurality of input data objects;
determining, by the one or more processors, an advantage ratio between the advantage parameter of the input data object and the aggregate advantage parameter of the plurality of input data objects; and
generating, by the one or more processors, the predictive weighting metric for the input data object based at least in part on the advantage ratio.

8. The computer-implemented method of claim 1, further comprising:
generating, by the one or more processors, a cohort predictive metric data object based at least in part on the predictive metric data object, wherein the cohort predictive metric data object is indicative of an average predictive metric data object for the input data object cohort.

9. The computer-implemented method of claim 8, further comprising:
identifying, by the one or more processors, an optimization cohort cluster for the input data object cohort based at least in part on the cohort predictive metric data object, wherein the optimization cohort cluster comprises one or more outlier input data objects of the input data object cohort.

10. The computer-implemented method of claim 9, further comprising:
generating, by the one or more processors, the processing optimization action for the predictive entity based at least in part on the optimization cohort cluster, wherein the processing optimization action comprises a processing recommendation for improving the cohort predictive metric data object of the input data object cohort.

11. The computer-implemented method of claim 10, wherein the processing optimization action for the predictive entity is based at least in part on one or more shared cluster attributes associated with at least one of the one or more outlier input data objects.

12. The computer-implemented method of claim 11, further comprising:
initiating, by the one or more processors, the processing optimization action;
generating, by the one or more processors, a second iteration cohort predictive metric data object; and
responsive to the second iteration cohort predictive metric data object not achieving an optimization threshold, generating, by the one or more processors, a second iteration processing optimization action for the predictive entity.

13. An apparatus for implementing an automatic data processing scheme for evaluating robust data sets to optimize procedure efficiency, the apparatus comprising at least one processor and at least one memory including program code, the at least one memory and the program code configured to, with the at least one processor, cause the apparatus to at least:
generate a weighting-based input data object parameter for a plurality of input data objects associated with a predictive entity;
generate a variance-based input data object cohort parameter for an input data object cohort comprising a subset of input data objects from the plurality of input data objects;
generate a predictive variance metric for an input data object of the input data object cohort based at least in part on the variance-based input data object cohort parameter and a first predictive metric attribute for the input data object;
generate a predictive weighting metric for the input data object based at least in part on the weighting-based input data object parameter and a second predictive metric attribute for the input data object;
generate a predictive metric data object for the input data object based at least in part on the predictive variance metric and the predictive weighting metric for the input data object; and
provide an indication of the predictive metric data object to the predictive entity.

14. The apparatus of claim 13, wherein the predictive variance metric is indicative of a number of standard deviations between the input data object and the variance-based input data object cohort parameter for the input data object cohort.

15. The apparatus of claim 14, wherein the first predictive metric attribute is indicative of cost parameter for the input data object, and wherein generating the predictive variance metric for the input data object comprises:
generating the variance-based input data object cohort parameter for the input data object cohort based at least in part on a median cost parameter of the input data object cohort;
determining the number of standard deviations between the input data object and the variance-based input data object cohort parameter based at least in part on the cost parameter and the median cost parameter; and
generating the predictive variance metric for the input data object based at least in part on the number of standard deviations between the input data object and the variance-based input data object cohort parameter.

16. The apparatus of claim 13, wherein generating the predictive metric data object for the input data object comprises:
aggregating, by the one or more processors, the first predictive metric attribute, the predictive variance metric, and the predictive weighting metric for the input data object.

17. A computer program product for implementing an automatic data processing scheme for evaluating robust data sets to optimize procedure efficiency, the computer program product comprising at least one non-transitory computer-readable storage medium having computer-readable program code portions stored therein, the computer-readable program code portions configured to:
generate a weighting-based input data object parameter for a plurality of input data objects associated with a predictive entity;
generate a variance-based input data object cohort parameter for an input data object cohort comprising a subset of input data objects from the plurality of input data objects;
generate a predictive variance metric for an input data object of the input data object cohort based at least in part on the variance-based input data object cohort parameter and a first predictive metric attribute for the input data object;
generate a predictive weighting metric for the input data object based at least in part on the weighting-based input data object parameter and a second predictive metric attribute for the input data object;
generate a predictive metric data object for the input data object based at least in part on the predictive variance metric and the predictive weighting metric for the input data object; and
provide an indication of the predictive metric data object to the predictive entity.

18. The computer program product of claim 17, further configured to:
generate a cohort predictive metric data object based at least in part on the predictive metric data object, wherein the cohort predictive metric data object is indicative of an average predictive metric data object for the input data object cohort.

19. The computer program product of claim 18, further configured to:
identify an optimization cohort cluster for the input data object cohort based at least in part on the cohort predictive metric data object, wherein the optimization cohort cluster comprises one or more outlier input data objects of the input data object cohort.

20. The computer program product of claim 19, further configured to:
generate a processing optimization action for the predictive entity based at least in part on the optimization cohort cluster, wherein the processing optimization action comprises a processing recommendation for improving the cohort predictive metric data object of the input data object cohort.
